(19) United States
(12) Patent Application Publication
(10) Pub. No.: US 2007/0257809 A1
(43) Pub. Date: Nov. 8, 2007

(54) Acoustic telemetry system optimization

(75) Inventors: Paul L. Camwell, Calgary (CA); Wendall L. Siemens, Calgary (CA); Derek W. Logan, Calgary (CA)

Correspondence Address: KLARQUIST SPARKMAN, LLP, 121 SW SALMON STREET, SUITE 1600, PORTLAND, OR, 97204, US

(73) Assignee: XAcT Downhole Telemetry Inc.

(21) Appl. No.: 11/786,521

(22) Filed: Apr. 11, 2007

Related U.S. Application Data
(60) Provisional application No. 60/790,803, filed on Apr. 11, 2006.

(51) Int. Cl. G01V 1/40

(52) U.S. Cl. 340/853.7; 340/853.8; 367/82

(57) ABSTRACT

A system and method of closed loop control whereby acoustic telemetry devices, both at surface and downhole, form nodes of a feedback loop; said feedback loop enables an automatic and dynamic means to modify transmission parameters such that the system's telemetry data rate is maximized consistent with minimum achievable signal-to-noise ratio and minimum expended power.

### CROSS REFERENCE TO RELATED APPLICATION

This application claims the benefit of U.S. provisional patent application Ser. No. 60/790,803, filed Apr. 11, 2006, which is incorporated herein by reference.

### FIELD

The present invention relates to telemetry apparatus and methods, and particularly to acoustic telemetry apparatus and methods used in the oil and gas industry associated with oil and gas exploration drilling, logging while drilling, oil and gas production, drilling applications of mining, and more particularly to the effect such devices have on the performance of acoustic telemetry transmitters.

### BACKGROUND

Acoustic carrier waves from an acoustic telemetry device are modulated in order to carry drilling information via the drill pipe to the surface. Upon arrival at the surface the waves are detected, decoded and displayed in order that drillers, geologists and others helping steer or control the well are provided with drilling and formation data. It is an object of this invention to enable the transmission and reception of these waves to compensate for the changes in noise and attenuation factors such that efficient use is made of the available downhole power while maximizing data throughput.

Acoustic telemetry as it relates to communication along drillpipe in particular is constrained by such pipe having periodic dimensional changes in its structure. This leads to a predictable filter structure being imposed on the passage of acoustic periodic energy waves as they travel along such pipe (D.S. Drumheller, Wave Impedances Of Drill Strings And Other Periodic Media, J. Acoustical Society of America, 112: 2527-2539, 2002). The filter structure is relatively comb-like in nature, having repeated passband/stopband effects, forcing practical acoustic telemetry designs to utilize and accommodate to the available passbands. The filter imposes inherent loss and phase dispersion mechanisms that constrain the bandwidth available for acoustic communications. Furthermore, the departure from ideal dimensions from one drillpipe to another (typically due to recuts) causes the passbands to generally degrade, usually via passband distortion and narrowing. Further barriers to communication include attenuation due to pipe/wall contact and noise associated with the drilling operations. The effects mentioned all reduce the signal-to-noise ratio (SNR) at receivers, either on surface or downhole, thus limiting parameters such as range or data rate. It is possible to improve SNR by, for example, increasing an acoustic transmitter's output power, but this is usually at the cost of battery life. These channel effects limit the present usefulness of acoustic telemetry in drilling environments. In addition, the channel effects vary, again depending on the particular drilling circumstances that apply, and thus the SNR also proportionately varies. In order to overcome this issue standard acoustic telemetry drilling implementations run at full power and at a data rate commensurate with the worst-case conditions, thereby leading to inefficient use of battery power and a non-optimal system performance.

### SUMMARY

It is an object of certain embodiments of the present invention to overcome non-optimal acoustic telemetry drilling performance by modifying communication parameters in line with changing downhole factors such as attenuation and in-band noise.

According to one aspect, there is provided a method of controlling acoustic telemetry transmission in a drillstring. The method comprises: assessing noise characteristics from one or more surface and downhole sources; determining a setting for one or more transmission parameters of a telemetry signal from a transmitter to a receiver in a drillstring and having a desired signal-to-noise ratio (SNR); and acoustically transmitting a telemetry signal at the determined parameter setting by the transmitter and/or receiving a telemetry signal at the determined parameter setting by the receiver. The desired SNR can be the SNR which provides a telemetry signal with an increased data rate and a transmitter transmitting at a reduced downhole power consumption, or ideally, a maximum data rate at a minimum downhole power consumption.

The parameters can include: passband filter settings; passband gain settings; signal amplitude; data rate; data packet repetition; carrier frequency excursion; carrier cycles per data bit; carrier frequency shift within a passband; passband channel shift; occupation of multiple passbands; and adaptive transmitted signal distortion.

The step of assessing can comprise predicting a change in noise characteristics and then determining a desired SNR having the predicted change in noise characteristic.

The method can further comprise transmitting a control signal to a downhole receiver having the parameter setting, communicating the parameter setting to a downhole transmitter, and then acoustically transmitting the telemetry signal from the downhole transmitter to a surface receiver having the parameter setting.

The downhole transmitter can transmit the telemetry signal to the surface receiver using at least one repeater. In such case, the method can further comprise measuring the noise characteristics at the downhole transmitter and at each repeater and transmitting the measured noise characteristics to the surface receiver for assessing. The method can then further comprise determining a setting for one or more transmission parameters of a telemetry signal for each repeater, then transmitting the control signal with the parameter setting for each repeater to each repeater.

According to another aspect, there is provided an acoustic telemetry transmission apparatus for a drillstring comprising:
(a) a transmitter in the drillstring;
(b) a receiver in the drillstring;
(c) a processor with a memory having recorded thereon steps and instructions to: assess noise characteristics from one or more surface and downhole sources; determine a setting for one or more transmission parameters of a telemetry signal from the transmitter to the receiver and having a desired signal-to-noise ratio (SNR); and instruct the transmitter to acoustically transmit a telemetry signal at the determined parameter setting and/or instruct the receiver to receive a telemetry signal at the determined parameter setting.

The transmitter can be a downhole transmitter and the receiver can be a surface receiver. In such case, the apparatus can further comprise a downhole receiver and a surface transmitter. The downhole receiver and transmitter can be combined into a transceiver of a downhole sub. The apparatus can further comprise at least one repeater in the drill string; in such case, the downhole sub is in acoustic communication with the surface receiver via the at least one repeater. At least one of the downhole sub and repeater can include means for measuring local noise characteristics and be configured to transmit the measured local noise characteristics to the surface receiver for assessment.

The memory can have further recorded thereon steps and instructions to instruct the surface transmitter to transmit a control signal to the downhole receiver having a parameter setting for the transmission of a telemetry signal by the downhole transmitter with the desired SNR. The memory can also have recorded thereon steps and instructions to determine a setting for one or more transmission parameters of a telemetry signal for each repeater, then instruct the surface transmitter to transmit the control signal with the parameter setting for each repeater to each repeater.

### BRIEF DESCRIPTION OF THE DRAWINGS

The following drawings illustrate the principles of the present invention and an exemplary embodiment thereof:

FIG. 1 represents an acoustic drilling scenario wherein a primary downhole transceiver sends data to a surface transceiver along drillpipe.

FIG. 2 represents a similar situation to FIG. 1 except that the drillpipe incorporates an acoustic repeater disposed between the surface transceiver and the primary downhole transceiver.

### DETAILED DESCRIPTION

The present embodiments seek to overcome non-optimal acoustic telemetry drilling performance by modifying communication parameters in line with changing downhole factors such as attenuation and in-band noise. This object is preferably addressed by information feedback between one or more transmitters and one or more receivers in order to maintain a defined optimal system performance. This involves both the downhole and surface telemetry equipment assessing noise, signal strength and rig operating circumstances such as drillpipe rotation, drilling fluid activity, etc. Once the system has assessed the SNR values at various appropriate points it is then able to autonomously modify various of the communication parameters in a dynamic manner (i.e. in close to real time) according to a preset optimal telemetry operating condition.

This capability in most situations will not require human intervention, and will have the beneficial effect of reducing the rig drilling time whilst operating the downhole telemetry devices in a highly efficient manner.

One situation where the within method is employed is the context of one downhole acoustic sub and one surface acoustic transceiver. The downhole sub is called a primary transceiver herein to denote its main function of collecting directional, drilling and formation dependent information and subsequently sending this information to the surface via acoustic waves, the sub also incorporating an acoustic or similar receiver in order to detect control and other messages. The surface receiver also has the capability to directly transmit control or other messages to the sub, or cause such transmission by other means. The added task of the surface receiver, according to the present invention, is to assess adequacy or inadequacy of the SNR, and in conjunction with the information of the rig operating circumstances initiate a control signal to be issued to the sub, thus completing a closed loop feedback system. The main goal of this system is to optimally achieve maximum decodable data rate with minimum power.

The next more complicated situation where the present method is employed is associated with a primary transceiver and similar repeating transceiver, the latter being disposed further along the drillpipe and therefore closer to the surface acoustic receiver. The repeater's function is to detect and decode the telemetry messages originating from the primary transceiver and retransmit same to the surface acoustic receiver. There are then two relatively independent closed loop feedback systems—one between the primary transceiver and the repeater, and one between the repeater and the surface acoustic receiver. In a similar manner as described above, each feedback loop enables the communication channels to be optimized. This situation obviously extends to multiple repeaters.

The present embodiments further apply to the situation where the repeaters simply pass on SNR information pertinent to their local circumstances. Subsequently at the surface a control message is broadcast, this message now being intended to modify in one instance the transmitting parameters of each subsurface sub. This could be beneficially implemented because much more power may be readily available at the surface so that an all-encompassing control signal can reach even to the furthermost transceiver, thus enabling all the downhole devices to modify their individual transmission parameters closer to their predetermined optima.

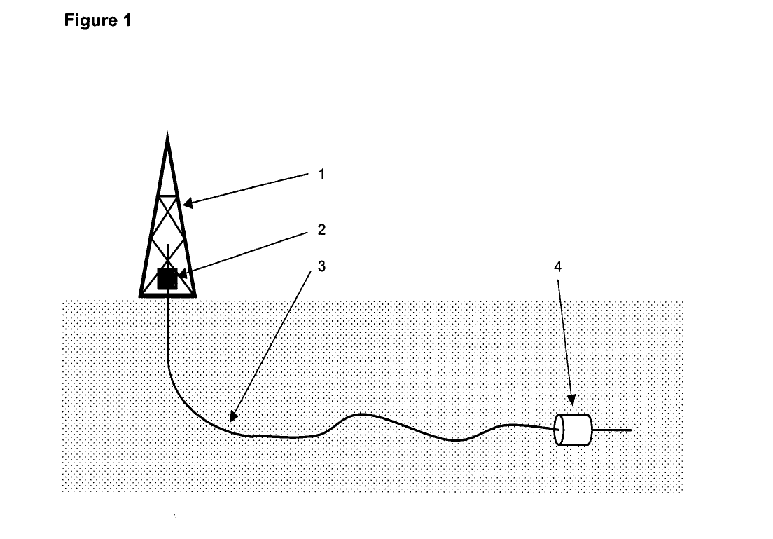

FIG. 1 denotes a basic embodiment whereby a drilling rig 1 drills a well with telemetry information being generated primarily by primary acoustic transceiver sub 4 along drillpipe 3 as a transmission medium. The sub 4 is normally part of a group of drilling-related components, such as a drill bit, a mud motor, etc., the ensemble being known as a ‘bottom hole assembly’ (BHA). The telemetry information is detected primarily by a surface transceiver 2 where it is decoded and passed on to drilling personnel as appropriate. Surface transceiver 2 also has the capability to assess noise from various surface and downhole sources, as is generally indicated below:

Surface:
top-drive motor or rotary table
diesel generator(s)
drilling fluid pumps
centrifuge and shaker tables

Downhole:
drill bit
mud motor or rotary steerable tool
drillpipe and BHA rotation
drillpipe and BHA sliding
drilling fluid motion

In particular, the sub 4 samples local downhole noise, and the surface transceiver 2 samples the filtered and attenuated noise as imposed by the drill string channel. Thus the sub samples “unfiltered noise” and would passband filter this noise so as to assess what the surface transceiver 2 would likely to receive. Conversely, the sub 4 receives filtered and attenuated noise originated mostly from the rig 1 at the surface, so it can assess the uphole noise condition more directly. The sub 4 receives the ensemble noise, determines what its receive SNR is and transmits this to the surface where appropriate action is taken by the surface transmitter.

If the transmission characteristics of the sub 4 remain the same, changes in the SNR are mainly determined by changes in these noise sources. Assuming that the noise is generally stable, options in varying SNR now fall to varying the setting of transmission parameters such as follows:

Surface:
acoustic transceiver passband filter settings
acoustic transceiver passband gain settings

Downhole:
signal amplitude
data rate
data packet repetition
wider carrier frequency excursion
more carrier cycles per data bit
carrier frequency shift within a passband
passband channel shift
occupation of more than one passband
adaptive transmitted signal distortion

The amount the SNR needs to be increased or decreased to achieve optimum performance can be readily pre-computed and a look-up table or similar can then be used in determining the best approach to change the setting of one or more of these parameters, with the aim being to achieve a minimum useful SNR consistent with maximum possible data rate and minimum downhole power consumption. If the noise is not stable, the situation is more complicated, but still amenable to the control as described—simply modified to account for the worst predicted SNR. The control information either directly or indirectly proceeds from the surface transceiver with signal parameters appropriate to ensure adequate detection by the downhole transceiver. Use can also be made of previously transmitted knowledge of the downhole transceiver's local SNR in order to achieve this goal.

Furthermore, use can also be made of changing surface noise that also has a bearing on the downhole noise environment. For instance, if the drillpipe rotation rate increases after reception of downhole data, the control signal can be modified to accommodate for the predicted increase in downhole noise, and thus reduction in net SNR.

Additionally, the converse of this situation can be utilized—if the downhole sub's instruments detect that all motion of the drillpipe has ceased, at least temporarily, it can transmit a signal containing its intentions to send its present telemetry data in a ‘burst mode’. It would then send this data at the highest feasible rate, and then shut down transmission until it was activated by the next downhole event (such as pipe motion, etc.). Sending data at a high rate not only improves the amount and timeliness of data available at the surface but also saves battery power, particularly in the case of acoustic telemetry. This latter is because the bulk of power consumption is related to transmitting time, thus the shorter the transmission the less power is used.

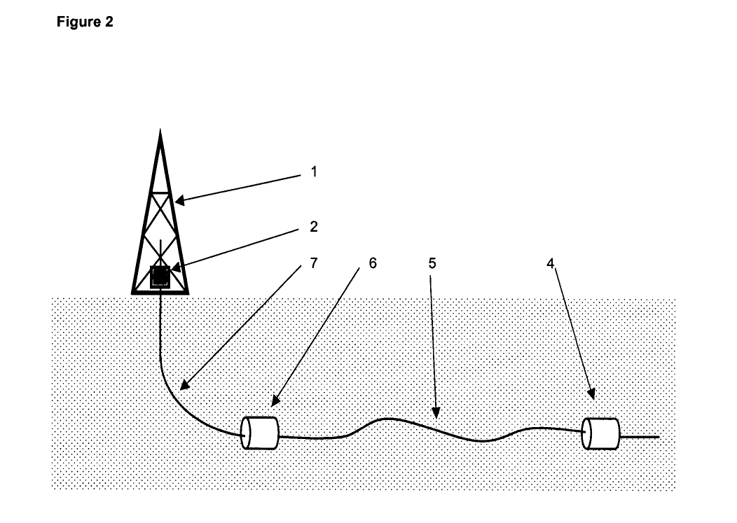

Another embodiment is exemplified by FIG. 2, wherein the situation is generally as discussed above, but with the inclusion of a repeater 6. Again, as above, the first control feedback loop is associated with the surface transceiver 2 and repeater 6, utilizing their common drillpipe channel 7. Relatively independent of this is the second control feedback loop associated with repeater 6 and sub 4, utilizing their common drillpipe channel 5. It is obvious that these means can be applied to two or more repeaters deployed along a drillstring.

In an extension of this embodiment, it may be beneficial to achieve the same goal of a minimum useful SNR for each repeater consistent with maximum data rate and minimum downhole power consumption but with the following modifications:
the primary emitter and each successive repeater passes its local SNR data onto the next station
the SNR values appropriate to the complete downhole system finally reach the surface transceiver
the surface transceiver then constructs a control message pertinent to each downhole transceiver and causes this to be broadcast in one or more transmissions
the signal strength of this control message is adequate to reach all of the downhole transceivers, enabling them all to reset their transmission parameters appropriately

The major advantages of this autonomous set of feedback loops are that adequate SNR values for each and every leg of the telemetry channel is achieved, if possible, in an automatic and dynamic manner; minimal power is used in achieving these SNR values; no human operator is needed for this function; lack of human intervention and achieving of local telemetry optima will enable faster and therefore cheaper drilling.

We claim:

1. A method of controlling acoustic telemetry transmission in a drillstring, comprising:
(a) assessing noise characteristics from one or more surface and downhole sources;
(b) determining a setting for one or more transmission parameters of a telemetry signal from a transmitter to a receiver in a drillstring and having a desired signal-to-noise ratio (SNR); and
(c) acoustically transmitting a telemetry signal at the determined parameter setting by the transmitter and/or receiving a telemetry signal at the determined parameter setting by the receiver.

2. A method as claimed in claim 1 wherein the one or more parameters are selected from the group consisting of: passband filter settings; passband gain settings; signal amplitude; data rate; data packet repetition; carrier frequency excursion; carrier cycles per data bit; carrier frequency shift within a passband; passband channel shift; occupation of multiple passbands; and adaptive transmitted signal distortion.

3. A method as claimed in claim 1 wherein the desired SNR provides a telemetry signal with an increased data rate and a transmitter transmitting at a reduced downhole power consumption.

4. A method as claimed in claim 1 wherein the step of assessing comprises predicting a change in noise characteristics and determining the desired SNR with the predicted change in noise characteristic.

5. A method as claimed in claim 1 further comprising detecting cessation of drill pipe motion and then acoustically transmitting a telemetry signal from the transmitter to the receiver having a burst mode parameter setting.

6. A method as claimed in claim 1 wherein in step (C) the transmitter is a downhole transmitter and the receiver is a surface receiver.

7. A method as claimed in claim 6 further comprising transmitting a control signal to a downhole receiver having the parameter setting, communicating the parameter setting to the downhole transmitter, and then acoustically transmitting the telemetry signal from the downhole transmitter to the surface receiver having the parameter setting.

8. A method as claimed in claim 6 wherein the downhole transmitter transmits the telemetry signal to the surface receiver using at least one repeater.

9. A method as claimed in claim 8 further comprising measuring the noise characteristics at the downhole transmitter and at each repeater and transmitting the measured noise characteristics to the surface receiver for assessing.

10. A method as claimed in claim 9 further comprising determining a setting for one or more transmission parameters of a telemetry signal for each repeater, then transmitting the control signal with the parameter setting for each repeater to each repeater.

11. An acoustic telemetry transmission apparatus for a drillstring comprising:
(a) a transmitter in the drillstring;
(b) a receiver in the drillstring;
(c) a processor with a memory having recorded thereon steps and instructions to
assess noise characteristics from one or more surface and downhole sources;
determine a setting for one or more transmission parameters of a telemetry signal from the transmitter to the receiver and having a desired signal-to-noise ratio (SNR); and
instruct the transmitter to acoustically transmit a telemetry signal at the determined parameter setting and/or instruct the receiver to receive a telemetry signal at the determined parameter setting.

12. An apparatus as claimed in claim 11 wherein the one or more parameters are selected from the group consisting of: passband filter settings; passband gain settings; signal amplitude; data rate; data packet repetition; carrier frequency excursion; carrier cycles per data bit; carrier frequency shift within a passband; passband channel shift; occupation of multiple passbands; and adaptive transmitted signal distortion.

13. An apparatus as claimed in claim 11 wherein in the transmitter is a downhole transmitter and the receiver is a surface receiver.

14. An apparatus as claimed in claim 13 further comprising a downhole receiver and a surface transmitter.

15. An apparatus as claimed in claim 14 wherein the memory has further recorded thereon steps and instructions to instruct the surface transmitter to transmit a control signal to the downhole receiver having a parameter setting for the transmission of a telemetry signal by the downhole transmitter having the desired SNR.

16. An apparatus as claimed in claim 14 further comprising a downhole sub comprising the downhole receiver and downhole transmitter.

17. An apparatus as claimed in claim 16 further comprising at least one repeater in the drill string and wherein the downhole sub is in acoustic communication with the surface receiver via the at least one repeater.

18. An apparatus as claimed in claim 17 wherein at least one of the downhole sub and repeater includes means for measuring local noise characteristics and is configured to transmit measured noise characteristics to the surface receiver for assessment.

19. An apparatus as claimed in claim 19 wherein the memory has further recorded thereon steps and instructions to determine a setting for one or more transmission parameters of a telemetry signal for each repeater, then instruct the surface transmitter to transmit the control signal with the parameter setting for each repeater to each repeater.
